(19) United States
(12) Patent Application Publication
(10) Pub. No.: US 2009/0241134 A1
(43) Pub. Date: Sep. 24, 2009

(54) REMOTE STORAGE SERVICE API

(75) Inventors: Stephen T. Garrity, Kirkland, WA (US); Michael Steven Vernal, San Francisco, CA (US); Aakash D. Kambuj, Kirkland, WA (US); Vladimir Dmitri Fedorov, Bellevue, WA (US); Ryan C. Bergauer, Redmond, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 12/054,355

(22) Filed: Mar. 24, 2008

(51) Int. Cl. G06F 3/00

(52) U.S. Cl. 719/328

(57) ABSTRACT

Techniques are disclosed to provide an application programming interface to access data stored in a remote storage service. The data may be of any type, and is stored in core objects.

### BACKGROUND

Data access is a requirement for many applications. Remote storage services allow data to be stored on servers so that it may be available broadly across locations and devices. Such services also often allow sharing of data among users, as well as having data private to an individual user.

There are many different ways used to access and update data stored in a remote storage service. Software developers must often create their own techniques to store, access, and update data, often making different application programming interfaces (APIs) for different types of data or in different applications. In addition, it is often necessary to provide multiple methods of accessing data to make it accessible to different types of devices.

### SUMMARY

An effective standardized way to provide a consistent programming interface for data access on a remote server would be a benefit to software developers.

Described herein are, among other things, techniques for providing a consistent application programming interface (API) to store, access, and update data stored in a remote storage service.

As used herein, a core object is a globally unique data storage unit that contains data securely accessible by a set of members and mapped to a set of devices. The core object may include such common metadata as an identifying field, a list of users and associated rights, such as read-only or read-write access, and other identifying, security, or administrative metadata. The core object may also have fewer items of metadata. Additionally, the core object may have included data, such as a news story, a personnel record, a drawing, or any other type of data which a software application may access. The included data may be added and updated from a software application used to access the data, or by a separate software application. In another implementation the included data may be updated automatically, using an RSS feed, for example. A core object may be replicated on multiple devices and accessed by multiple users.

By using a core object, a standard API may be used to access data of many different types. In one implementation, the API supports creation, updating, and deleting data and metadata in a core object through the use of http commands. In this implementation, POST creates a new core object, GET reads some or all of the data in a core object, PUT updates a core object, and DELETE deletes a core object. In other implementations, these same http commands work on component parts of a core object, so that, for example, POST creates a new data feed, data entry, member mapping, or the like in a core object. In some implementations there is a merge command, which allows the merging of RSS resources supporting simple sharing extension (SSE).

### DESCRIPTION OF THE DRAWINGS

A further understanding of the various embodiments of the present invention may be realized by reference to the figures, which are described in remaining portions of the specification. In the figures, like reference numerals are used throughout several drawings to refer to similar components.

FIG. 1 is a block diagram of a sample operating environment in which a remote storage service API may be implemented.

FIG. 2 shows example objects that may be accessed using the storage server API.

FIG. 3 shows a flow chart of one implementation for an update operation.

FIG. 4 depicts an example of a system in accordance with various embodiments of the present invention.

### DETAILED DESCRIPTION

Various embodiments of the present invention provide techniques for accessing data stored in a remote storage service.

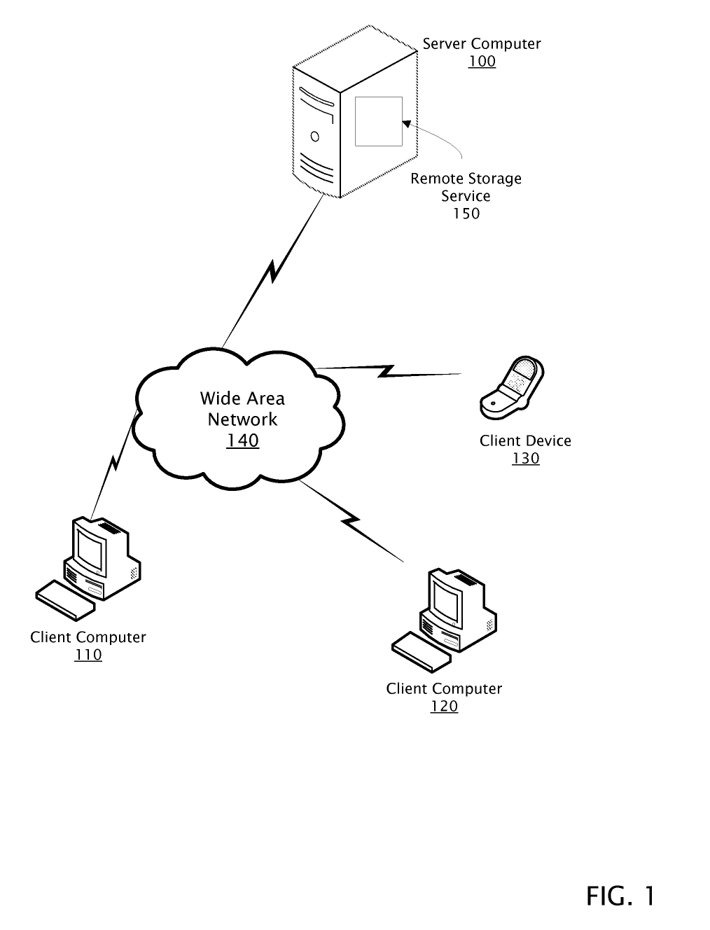

FIG. 1 is a block diagram showing a demonstrative operating environment in which remote storage service APIs may be implemented. In this example, client computer 110, client computer 120, and client device 130 are connected to server computer 100 via wide area network 140. One skilled in the art will recognize that client devices 110, 120, 130 may take on many different forms, including but not limited to personal computers, server computers, cellular phones, laptop computers, or any other type of device capable of submitting a request to server computer 100. Server computer 100 includes remote storage service 150.

Remote storage service 150 includes techniques of storing data, using the core object described above. Additionally, it provides a standard API to access the core objects stored therein.

In alternate implementations, there may not be a network connection to server computer 110, which may also be a workstation or client computer. In at least one alternate implementation, data is transferred from a client device to the remote storage service by removable computer-readable media. In another implementation, there may be more than client computers or other devices connected to the wide area network 140. In yet another implementation, server computer 110 is connected to one or more client computers via a local area network. In another implementation, client computers and other devices may communicate with server computer 100 via the internet.

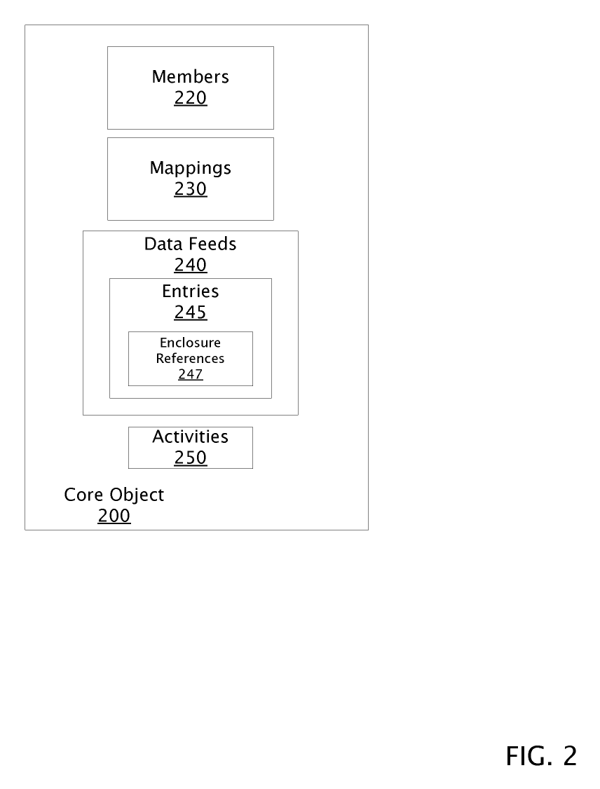

FIG. 2 is a block diagram of an example of a core object 200. In this example, Members 220 is a list of the members of the core object, including both sources and sinks. Activities are the set of things that users are doing in that core object, what devices are connected, or other types of ephemeral data. Mappings 230 defines the set of logical devices to which the core object 200 is mapped.

Data feeds 240 contain entries 245, which contain the user data stored in the core object. Enclosure references 247 contain pointers to large blocks of binary data (blobs) stored externally to the core object. In this example, the data is stored by a service which allows access based on a hash of the contents of the blob.

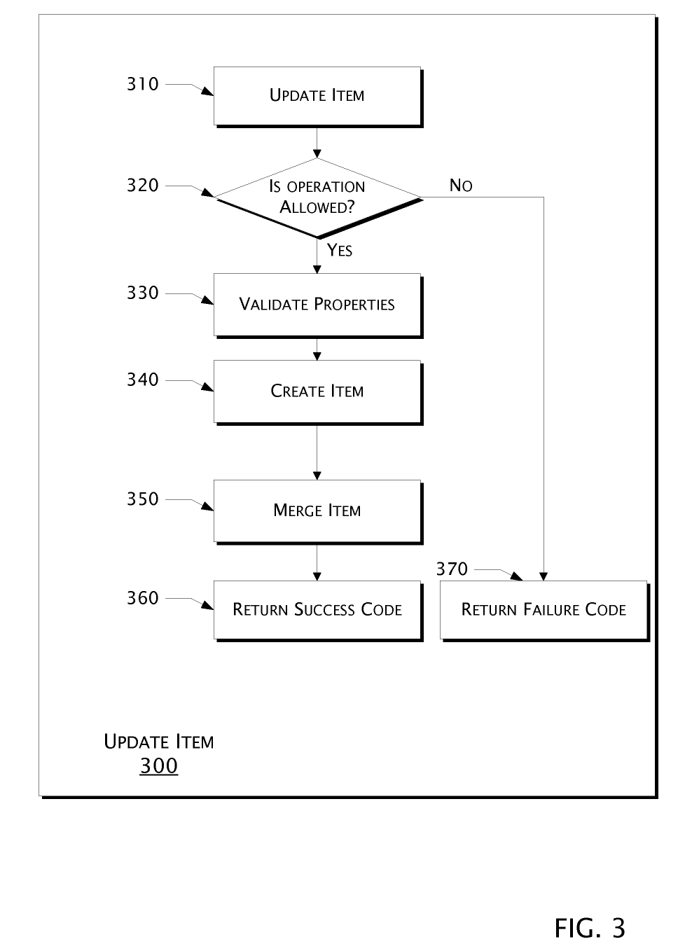

FIG. 3 is a flow chart 300 showing one implementation for updating a core object. Update Item API 310 is called, and a test 320 is performed to see if the operation is allowed. This test validates that the user and device calling for the update has permission to make the update. If not, a failure code is returned 370. Otherwise, the properties are validated 330. This test checks that the data being passed corresponds to the types in the core object being accessed, and that the data does not contain invalid values. Once the properties are validated, an item is created 340 and merged 350, replacing the original item. A success code is then returned 360.

In at least one implementation, the protocol will be RESTful, meaning it uses a style of Representational State Transfer (REST), using a series of verbs such as Create, Read, Update, and Delete that operate on a series of objects defined in an object model for a core object. In some examples, the verb Merge may also be implemented, conforming to Simple Sharing Extensions (SSE), which are extensions to Atom or RSS.

Accordingly, in some implementations, the operations on a core object may be done in accordance with the following pseudocode examples:

```
CreateItem<Type>(item) {
    IsOperationAllowed( );
    ValidateProperties( );
    newFeed = CreateSseFeedFromAtomItem(item,UPDATE);
    MergeItems(newFeed);
}
UpdateItem<Type>(item) {
    IsOperationAllowed( );
    ValidateProperties( );
    newFeed = CreateSseFeedFromAtomItem(item,UPDATE);
    MergeItems(newFeed);
}
ReadItem<Type>(item) {
    IsOperationAllowed( );
    GetItemFromDatabase( );
}
DeleteItem<Type>(item) {
    IsOperationAllowed( );
    ValidateProperties( );
    newFeed = CreateSseFeedFromAtomItem(item,UPDATE);
    MergeItems(newFeed);
}
MergeItems<Type>(newFeed) {
    IsOperationAllowed( );
    ValidateProperties( );
    currentFeed = readCurrentSseFeed( );
    mergedFeed = SseMergeAlgorithm(currentFeed,newFeed);
    CommitMergedFeed(mergedFeed);
}
CreateSseFeedFromAtomItem(item, method) {
    switch(method) {
    case CREATE:
        return new SseFeed(item);
    case UPDATE:
        return new SseFeed(GetSyncHistoryForItem(item));
    case DELETE:
        return new SseFeed(CreateTombstone(item));
    }
}
```

One skilled in the art will appreciate that additional operations may be implemented, not all implementations may use all of the available operations, and that the operations may be implemented in different manners.

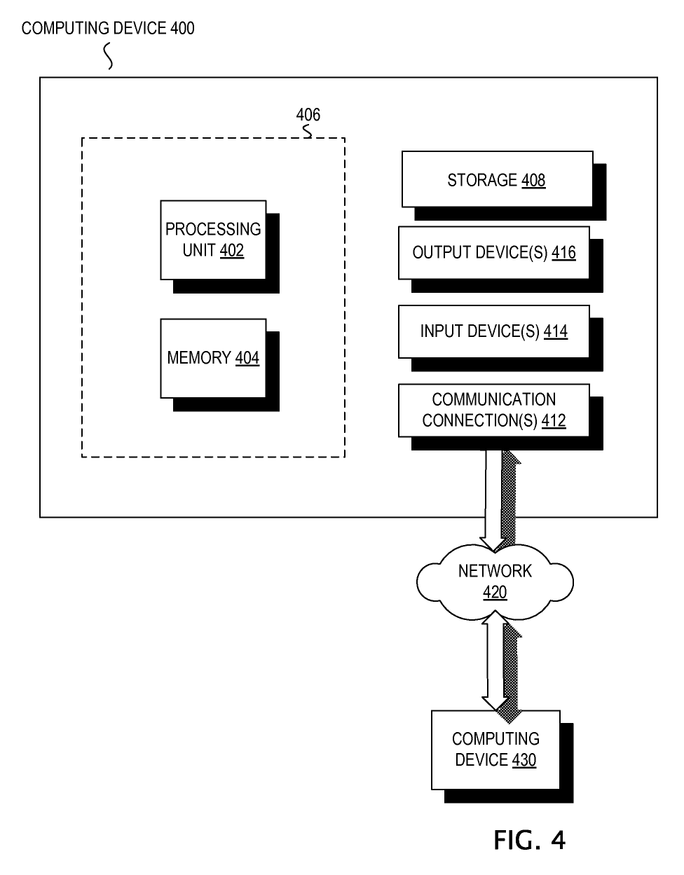

FIG. 4 shows an example of a computing device 400 for implementing one or more embodiments of the invention. In one configuration, computing device 400 includes at least one processing unit 402 and memory 404. Depending on the exact configuration and type of computing device, memory 404 may be volatile (such as RAM), non-volatile (such as ROM, flash memory, etc.) or some combination of the two. This configuration is illustrated in FIG. 4 by dashed line 406.

In other embodiments, device 400 may include additional features and/or functionality. For example, device 400 may also include additional storage (e.g., removable and/or non-removable) including, but not limited to, magnetic storage, optical storage, and the like. Such additional storage is illustrated in FIG. 4 by storage 408. In one embodiment, computer readable instructions to implement embodiments of the invention may be in storage 408. Storage 408 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 404 and storage 408 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 400. Any such computer storage media may be part of device 400.

Device 400 may also include communication connection(s) 412 that allow device 400 to communicate with other devices. Communication connection(s) 412 may include, but is not limited to, a modem, a Network Interface Card (NIC), or other interfaces for connecting computing device 400 to other computing devices. Communication connection(s) 412 may include a wired connection or a wireless connection. Communication connection(s) 412 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, Near Field Communication (NFC), and other wireless media.

Device 400 may include input device(s) 414 such as keyboard, mouse, pen, voice input device, touch input device, infrared cameras, video input devices, and/or any other input device. Output device(s) 416 such as one or more displays, speakers, printers, and/or any other output device may also be included in device 400. Input device(s) 414 and output device(s) 416 may be connected to device 400 via a wired connection, wireless connection, or any combination thereof. In one embodiment, an input device or an output device from another computing device may be used as input device(s) 414 or output device(s) 416 for computing device 400.

Components of computing device 400 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 400 may be interconnected by a network. For example, memory 404 may be comprised of multiple physical memory units located in different physical locations interconnected by a network.

Those skilled in the art will realize that storage devices utilized to store computer readable instructions may be distributed across a network. For example, a computing device 430 accessible via network 420 may store computer readable instructions to implement one or more embodiments of the invention. Computing device 400 may access computing device 430 and download a part or all of the computer readable instructions for execution. Alternatively, computing device 400 may download pieces of the computer readable instructions, as needed, or some instructions may be executed at computing device 400 and some at computing device 430. Those skilled in the art will also realize that all or a portion of the computer readable instructions may be carried out by a dedicated circuit, such as a Digital Signal Processor (DSP), programmable logic array, and the like.

Although some particular implementations of systems and methods have been illustrated in the accompanying drawings and described in the foregoing Detailed Description, it will be understood that the systems and methods shown and described are not limited to the particular implementations described, but are capable of numerous rearrangements, modifications and substitutions without departing from the spirit set forth and defined by the following claims.

In conclusion, the present invention provides novel systems, methods and arrangements for providing access to object properties. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A computer-readable storage medium with computer-readable instructions stored thereon that, when executed, implement a method comprising:
receiving a request to perform an operation on a data item enclosed in a core object, the request transferred via a RESTful protocol; and
performing the operation on the data item enclosed in the core object.

2. The method of claim 1 wherein the received request corresponds to a create command, and results in the data item being added to the core object.

3. The method of claim 1 wherein the request corresponds with a delete command, and results in the data item being removed from the core object.

4. The method of claim 1 wherein the request corresponds to an update command, and results in the data item being updated in the core object.

5. The method of claim 1 wherein the request corresponds to a read command, and results in the data item being returned to a module that made the request.

6. The method of claim 1 wherein the request corresponds to an merge command, and results in the data item being merged with existing data in the core object.

7. A system comprising:
a processor;
a receiving module configured to receive a request via a RESTful protocol, the request comprising an operation, a core object identification, a data item, and data;
a creation module configured to create the data item with the data in the identified core object;
an update module configured to update the data item with the data in the identified core object;
a delete module configured to delete the data item in the identified core object;
a read module configured to return the data item from the identified core object; and
a replication module configured to replicate the identified core object to other devices.

8. The system of claim 7 wherein the processor further comprises a personal computer.

9. The system of claim 7 wherein the processor further comprises a server computer.

10. The system of claim 7 further comprising a network connection.

11. The system of claim 10 wherein the network connection provides access to the receiving module via a local area network.

12. The system of claim 10 wherein the network connection provides access to the receiving module via a corporate intranet.

13. The system of claim 10 wherein the network connection provides access to the receiving module via the internet.

14. A system comprising:
a processor;
a sending module configured to send a request via a RESTful protocol, the request comprising an operation, a core object identification, a data item, and data; and
a receiving module configured to receive results of requests.

15. The system of claim 14 wherein the processor further comprises a personal computer.

16. The system of claim 14 wherein the processor further comprises a server computer.

17. The system of claim 14 wherein the processor further comprises a cellular phone.

18. The system of claim 14 wherein the processor further comprises a laptop computer.

19. The system of claim 14 wherein a core object identified by the core object identification is replicated to the processor.

20. The system of claim 14 wherein the receiving module is further configured to receive results via a RESTful protocol.
